(19) United States
(12) Patent Application Publication
(10) Pub. No.: US 2013/0112074 A1
(43) Pub. Date: May 9, 2013

(54) Support Mechanism for the Fluid End of a High Pressure Pump

(71) Applicant: Tony M. Small, Fort Worth, TX (US)

(72) Inventor: Tony M. Small, Fort Worth, TX (US)

(73) Assignee: FTS International, LLC, Fort Worth, TX (US)

(21) Appl. No.: 13/288,092

(22) Filed: Nov. 3, 2011

(51) Int. Cl. F04B 19/22; F04B 23/00; F16J 10/02

(52) U.S. Cl. 92/161; 92/169.1; 417/437

(57) ABSTRACT

A fluid end for a high pressure pump is mounted to the power end in such a manner so as to allow free access to the plunger portion of the fluid end for maintenance or removal of the fluid end. The fluid end sits on a mounting plate which has a key slot. The lower surface of the fluid end also has a key slot and a shear bar is located within the slots. The fluid end further includes a plurality of tensile studs that secure the fluid end to the mounting plate which is secured to a support frame.

### BACKGROUND OF INVENTION

1. Field of the Invention

This invention relates to a high pressure pump which typically is composed of a fluid end and a power end. High pressure fluid pumps are used in many applications during the drilling and completion of an oil or gas well. One process called tracing normally utilizes several high pressure pumps in unison to inject a tracing fluid into the well in order to create small cracks or fractures in the formation to allow the oil and/or gas to escape from the formation.

2. Description of Related Art

The fluid end and power end of existing high pressure pumps are connected together in such a way that the fluid end is essentially supported in a cantilever fashion. FIG. 1 of the application discloses such an arrangement. Power end 10 of pump 1 is normally mounted on a frame or truck bed. A plurality of stay rods 12 extend outwardly from the power end and are secured to the fluid end 11 along upper and lower flanges 15 and 14. Stay rods may be threaded at their outer ends and nuts 47 may be used to secure the fluid end of the pump to the stay rods. This type of support is commonly referred to as a cantilever support and requires a large number of stay rods between the power end and the fluid end and creates high stress levels at the point where the stay rods are connected to the fluid end and the power end of the pump.

A regular required maintenance task for the type of pump shown in FIG. 1 is to replace the plungers 16 and packing for the plungers. In order to accomplish this in the field, adaptors 17 between the pony rods 13 and the plungers 16 as shown in FIG. 2 must be removed and the packing nut 19 must also be removed. Due to the limited physical space due to the stay rods between the fluid end and the power end, this becomes a time consuming task. Also, should the entire fluid end need replacing, the fluid end must be supported in some manner as the stay rods are detached from the fluid end. Once again this is a time consuming task which results in down time and lost revenues.

### BRIEF SUMMARY OF THE INVENTION

The invention eliminates the need for the stay rods by supporting the fluid end in a completely different manner. The fluid end and the power end are supported on a common frame. The support for the fluid end includes amounting plate provided with a transversely extending slot. A complimentary slot is formed in the base portion of the fluid end and a suitably sized shear bar is positioned within the slot to absorb any horizontal forces caused by the reciprocating plungers. A plurality of tensile studs extend from a top portion of the fluid end into the mounting plate and thereby take up all the vertical loads placed on the fluid end. This arrangement provides for easy access to the space between the fluid end and the power end to thereby simplify normal maintenance procedures. It also greatly simplifies replacement of the entire fluid end in the field should that be necessary. This design also eliminates the need for replacing the stay rods and nuts as they degrade due to the thrust loads on the plungers.

### BRIEF DESCRIPTION OF THE SEVERAL VIEWS OF THE DRAWING(S)

FIG. 1 is a perspective view of a high pressure pump showing the conventional cantilever support for the fluid end of the pump.

FIG. 2 is a top view of an embodiment of the invention.

FIG. 3 is a cross sectional view of the pump according to an embodiment of the invention taken along lines 3-3 of FIG. 2.

FIG. 4 is a cross-sectional view of the fluid end and mounting plate showing the tensile stud bores.

### DETAILED DESCRIPTION OF THE INVENTION

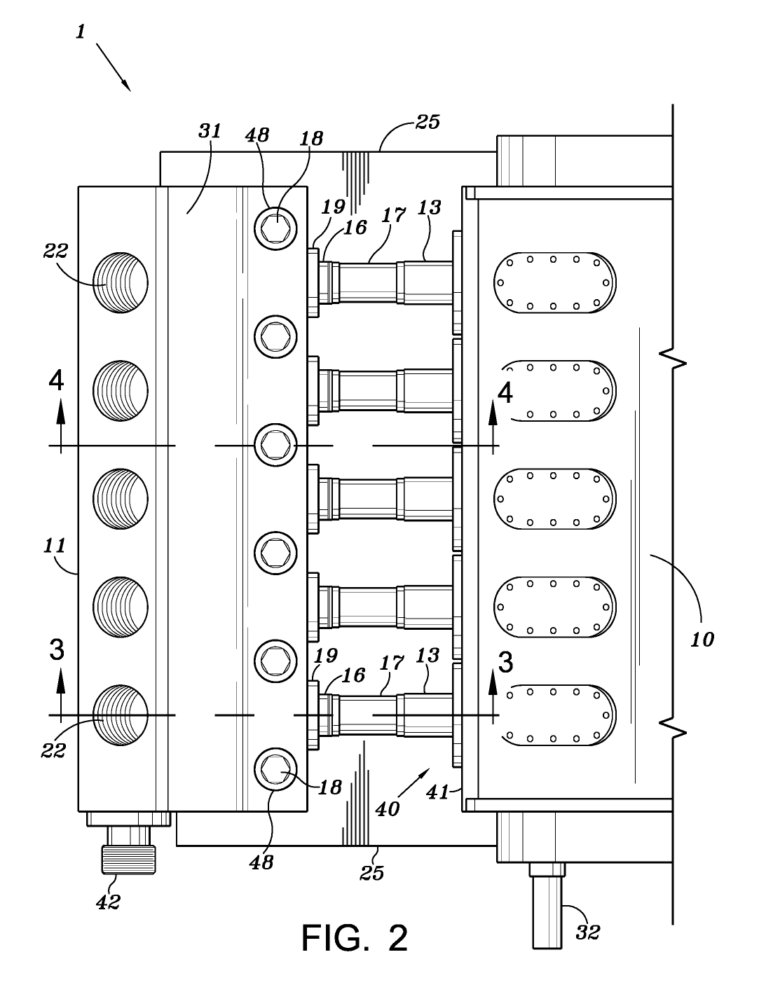

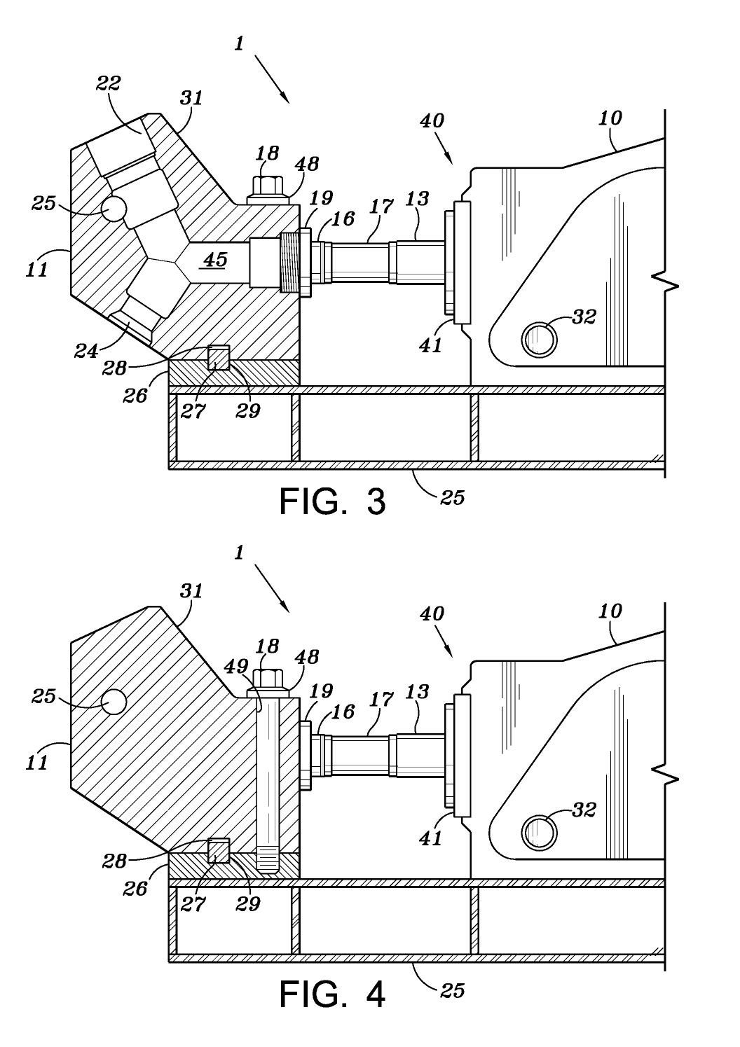

An embodiment of the invention is shown in FIGS. 2 and 3 and includes a fluid end 31 and a power end 40 which includes a drive input shaft 32. Fluid end 31 is formed from a solid block of stock material and is machined into the shape as shown in FIGS. 2 and 3. Fluid end 31 has a plurality of suction bores 24, outlet bores 22, and piston bores 45 formed therein as is shown in FIG. 2.

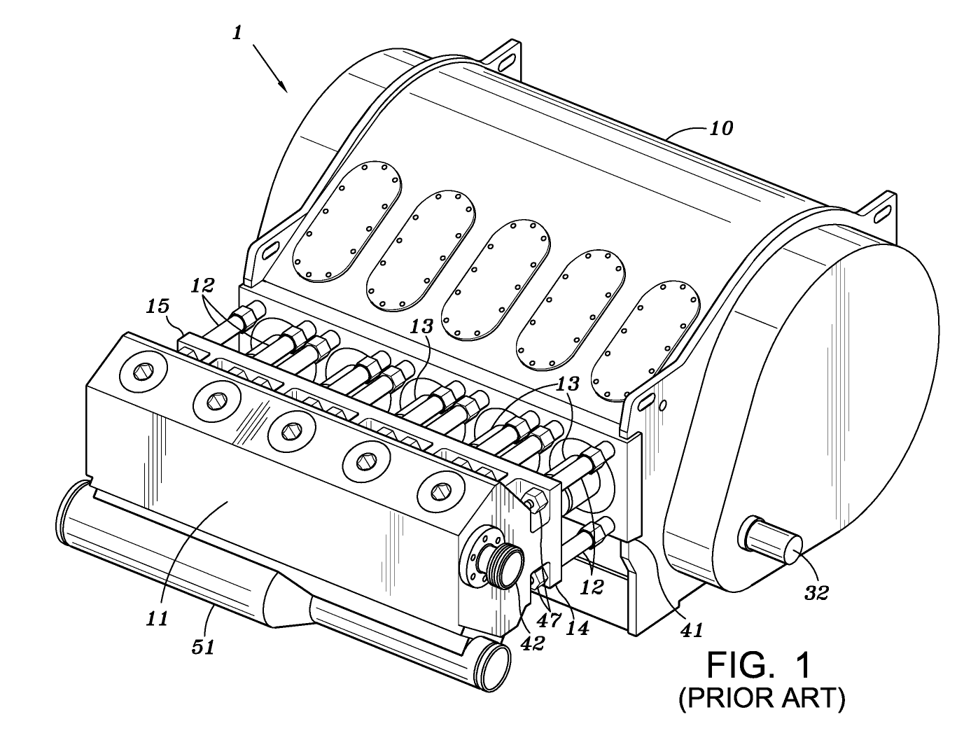

Fluid end 31 has a suction manifold attached to it similar to that shown at 51 in FIG. 1. Each outlet bore is in fluid communication with a transversely extending outlet passageway 25 for the high pressure fluid.

The fluid end includes a plurality of pump chambers, five of which are shown in FIG. 1. Referring to FIG. 3, an embodiment of the invention includes base support frame 25 for the pump. Power end 40 is supported on a first portion of the frame. At an opposite portion of the frame, a mounting plate 26 is secured to the support frame by any known means such as welding. Mounting plate 26 has a transversely extending key slot 29 which may be for example rectangular in shape. A complementary shaped slot 28 is formed in a lower portion of fluid end 31 as shown in FIG. 2. The top portion of slot 28 may have curved corners. Fluid end 31 also includes a plurality of vertical bores 49 for receiving tensile studs 18. Tensile studs 18 extend through the bores and have threaded ends that engage threaded sockets in mounting plate 26. Tensile studs 18 have an enlarged head portion 48 that engages an upper surface of the fluid end 31 thereby securing the fluid end on mounting plate 26 as shown in FIG. 4. Finally a shear bar 27 is positioned in key slots 28 and 29. The bar may be of any suitable length and shape.

According to the design of the invention, the shear bar takes up most of the axial load generated by the pump plungers and the tensile studs take up all vertical loads that may exist in the pumping process.

As shown in FIG. 3, the pony rods 13 from the power end 40 are connected to pump plungers 16 by an adapter 17, as is known in the art. See for example U.S. publication No. US 2011/0138997 published Jun. 16, 2011. Fluid end 31 also includes a packing nut 19 for each plunger. When it is necessary to service or replace the pump plungers and or plunger packing, adapters 17 are disconnected from the pony rods and the plungers. Packing nuts 19 and plungers 16 can be easily removed allowing for replacement of the plungers and packing. Furthermore, should the fluid end itself need to be replaced, tensile studs 18 can be removed. The entire fluid end can then be raised off the mounting plate 26 and a replacement unit can then be put in place.

I claim:

1. A fluid end for a high pressure pump comprising:
a. a body having a plurality of suction bores, outlet bores, and plunger bores formed therein,
b. a plurality of vertically extending tensile stud bores in said body for receiving a plurality of tensile studs, and
c. a key slot extending along a lower surface of the body adapted to receive an upper portion of a shear bar.

2. A fluid end as claimed in claim 1 wherein the lower surface of the body is a substantially flat, planar surface.

3. A fluid end according to claim 1 further including a suction manifold connected to the fluid end.

4. A fluid end according to claim 3 further including an outlet passageway in fluid communication with the outlet bores.

5. A fluid end according to claim 1 further including a plurality of suction valves, outlet valves, and plungers.

6. A high pressure fluid pump assembly comprising:
a. a support frame,
b. a power end supported on the frame and including a plurality of pony rods,
c. a mounting plate secured to the frame and having a transverse key slot in an upper surface of the mounting plate,
d. a fluid end mounted on the mounting plate, the fluid end including;
1. a body having a plurality of suction bores, outlet bores, and plunger bores formed therein,
2. a plurality of vertically extending tensile stud bores for receiving a plurality of tensile studs,
3. a key slot extending along a lower surface of the fluid end body adapted to receive an upper portion of a shear bar,
e. a plurality of tensile studs extending through the stud bores and secured to the mounting plate,
f. a shear bar extending within the key slots located in the mounting plate and body,
g. a plurality of plungers extending within the plunger bores in the fluid end, and
h. a plurality of removable adapters interconnecting the plungers with the pony rods in the power end.

7. A high pressure fluid pump according to claim 6 further including a plurality of suction valves, outlet valves, and plungers.

8. A high pressure pump assembly as claimed in claim 7 further including a suction manifold connected to the fluid end and an outlet passageway in the fluid end that is in fluid communication with the outlet bores.

9. A high pressure pump assembly comprising:
a. a support frame,
b. a power end supported on the frame,
c. a mounting plate secured to the frame having a transverse key go an upper surface of the mounting plate,
d. a fluid end having a key slot in a lower portion thereof an a plurality of tensile stud bores,
e. a plurality of tensile studs extending through the tensile stud bores and secured to the mounting plate, and
f. a shear bar extending within the key slots located in the mounting plate and the fluid end.
